(19) United States
(12) Patent Application Publication
(10) Pub. No.: US 2024/0346158 A1
(43) Pub. Date: Oct. 17, 2024

(54) UNAUTHORIZED ACCESS DETECTION DEVICE AND METHOD

(71) Applicant: Hitachi, Ltd., Tokyo (JP)

(72) Inventors: Kiyomi WADA, Tokyo (JP); Mineyoshi MASUDA, Tokyo (JP)

(21) Appl. No.: 18/236,464

(22) Filed: Aug. 22, 2023

(30) Foreign Application Priority Data
Apr. 14, 2023 (JP) 2023-066438

(51) Int. Cl. G06F 21/60

(52) U.S. Cl. CPC G06F 21/604; G06F 2221/2101; G06F 2221/2113; G06F 2221/2137

(57) ABSTRACT

To reduce a risk of detecting an access within a range of temporarily elevated access authority as an unauthorized access, an unauthorized access detection device stores elevated access management data related to an elevated access operation (an operation within a range of temporarily elevated access authority) performed on a system. An operation log source that is a source of an operation log is configured to accumulate operation logs of operations as the elevated access operation on the system, as well as operation logs of operations other than the elevated access operation. The unauthorized access detection device acquires an operation history (one or more operation logs) from the operation log source, and performs determination on whether a response is required that is a determination on whether an operation identified from the operation history is an operation as an unauthorized access not matching an operation identified from the elevated access management data.

### CROSS-REFERENCE TO RELATED APPLICATION

The present application claims priority from Japanese application JP2023-066438, filed on Apr. 14, 2023, the content of which is hereby incorporated by reference into this application.

### TECHNICAL FIELD

The present invention generally relates to detection of an unauthorized access.

### BACKGROUND ART

In a cloud environment (for example, a public cloud environment) system, an unauthorized access can be made through a plurality of portions. Unauthorized accesses, not limited to the cloud environment, are becoming more and more sophisticated.

A technique disclosed in PTL 1 includes acquiring diagnosis information from an event, generating a graphic data structure based on correlation between events, and tracking a trace of an intruder to recognize the activity of the intruder.

A technique disclosed in PTL 2 includes scoring access authority associated with a resource in terms of risk level, based on the attributes of the resource and the authority.

### CITATION LIST

### Patent Literature

PTL 1: U.S. Pat. No. 10,521,584B
PTL 2: U.S. Pat. No. 11,323,470B

### SUMMARY OF INVENTION

### Technical Problem

There has been known a technique of temporarily elevating access authority and permitting an access within a range of the access authority elevated.

Unfortunately, a risk of an authorized access within the range of the access authority temporarily elevated erroneously detected as an unauthorized access may increase, since the elevation of the access authority is temporary. The unauthorized access needs to be confirmed and responded, and thus the increase in erroneously detected unauthorized accesses leads to a larger load for the confirmation and response.

### Solution to Problem

An unauthorized access detection device stores, in a storage device, elevated access management data that is data related to an elevated access operation (an operation within a range of temporarily elevated access authority) performed on an operation target system by a user. An operation log source that is a source of an operation log for an operation performed by the user on the operation target system is configured to accumulate operation logs of operations as the elevated access operation on the operation target system, as well as operation logs of operations other than the elevated access operation. The unauthorized access detection device acquires an operation history that is one or more operation logs from the operation log source, stores the operation history in the storage device, and acquires the elevated access management data from the storage device. The unauthorized access detection device performs determination on whether a response is required that is a determination on whether an operation identified from the operation history is an operation as an unauthorized access not matching an operation identified from the elevated access management data, and provides a result of the determination on whether a response is required.

### Advantageous Effects of Invention

According to the present invention, risk of detecting an access within a range of temporarily elevated access authority as an unauthorized access can be reduced.

### BRIEF DESCRIPTION OF DRAWINGS

FIG. 1 is a diagram illustrating an overall configuration of a system including an unauthorized access detection device according to an embodiment of the present invention.

FIG. 2 is a diagram illustrating a configuration of the unauthorized access detection device.

FIG. 3 is a schematic view of an elevated access workflow.

FIG. 4 is a schematic view of an event workflow.

FIG. 5 is a schematic view of a log workflow.

FIG. 6 is a schematic view of an evaluation workflow.

FIG. 7A is a diagram illustrating a configuration of a configuration table.

FIG. 7B is a diagram illustrating a configuration of an authority table.

FIG. 7C is a diagram illustrating a configuration of a record table.

FIG. 8A is a diagram illustrating a configuration of an event table.

FIG. 8B is a diagram illustrating a configuration of a condition table.

FIG. 8C is a diagram illustrating a configuration of a history table.

FIG. 8D is a diagram illustrating a configuration of an operation table.

FIG. 9A is a diagram illustrating a configuration of a forecast and actual record table.

FIG. 9B is a diagram illustrating a configuration of a workflow log table.

FIG. 10 is a flowchart illustrating response requirement determination processing.

FIG. 11 is a flowchart of use record collection processing.

FIG. 12 is a schematic view of a security event screen.

FIG. 13 is a schematic view of an inspected log screen.

FIG. 14 is a schematic view of an access authority screen.

### DESCRIPTION OF EMBODIMENTS

In the following description, an “interface device” may be one or more interface devices. The one or more interface devices may be at least one of the following.
One or more input/output (I/O) interface devices. An I/O interface device is an interface device for at least one of an I/O device and a remote display computer. The I/O interface device for the display computer may be a communication interface device. At least one I/O device may be any of a user interface device, for example, an input device such as a keyboard and a pointing device, and an output device such as a display device.
One or more communication interface devices. One or more communication interface devices may be one or more homogenous communication interface devices (for example, one or more network interface cards (NICs)) or two or more heterogeneous communication interface devices (for example, NICs and host bus adapter (HBAs)).

In addition, in the following description, a “memory” is one or more memory devices that are examples of one or more storage devices, and may typically be a main storage device. At least one memory device in the memory may be a volatile memory device or a non-volatile memory device.

In addition, in the following description, a “persistent storage device” may be one or more persistent storage devices that are examples of one or more storage devices. The persistent storage device may typically be a non-volatile storage device (for example, an auxiliary storage device), and may specifically be, for example, a hard disk drive (HDD), a solid state drive (SSD), a non-volatile memory express (NVME) drive, or a storage class memory (SCM).

In addition, in the following description, a “processor” may be one or more processor devices. At least one processor device may typically be a microprocessor device such as a central processing unit (CPU), or may be a processor device of another kind such as a graphics processing unit (GPU). At least one processor device may be single-core or multi-core. At least one processor device may be a processor core. At least one processor device may be a processor device in a broad sense such as a circuit (for example, a field-programmable gate array (FPGA), a complex programmable logic device (CPLD), or an application specific integrated circuit (ASIC)) that is an aggregation of gate arrays in a hardware description language that performs some or all of processing.

In addition, in the following description, a function is described by an expression of a “yyy unit” in some cases, but the function may be realized by one or more computer programs executed by a processor, by one or more hardware circuits (for example, the FPGAs or the ASICs), or by a combination thereof. In the case where the function is realized by the programs executed by the processor, the function may be at least a part of the processor because prescribed processing is performed by appropriately using a storage device and/or an interface device. The processing described using the function as a subject may be processing performed by a processor or a device having the processor. The programs may be installed from a program source. The program source may be, for example, a program distribution computer or a computer-readable recording medium (for example, a non-transitory recording medium). The description of each function is an example, and a plurality of functions may be combined into one function, or one function may be divided into a plurality of functions.

Further, in the following description, although data from which an output is obtained with respect to an input is described by an expression such as an “xxx table” in some cases, the data may be data of any structure (for example, may be structured data or unstructured data), a neural network for generating an output with respect to an input, or a learning model typified by a genetic algorithm or a random forest. Thus, the “xxx table” can be referred to as “xxx data.” In addition, in the following description, the configuration of each table is an example, and one table may be divided into two or more tables, or all or some of two or more tables may be one table.

In the following description, in the case where elements of the same kind are described without distinguishing them from each other, a common code among reference codes is used, and in the case where elements of the same kind are distinguished from each other, reference codes are used in some cases.

An embodiment of the present invention will be described with reference to the drawings. In the drawings, “WF” represents “workflow” as appropriate.

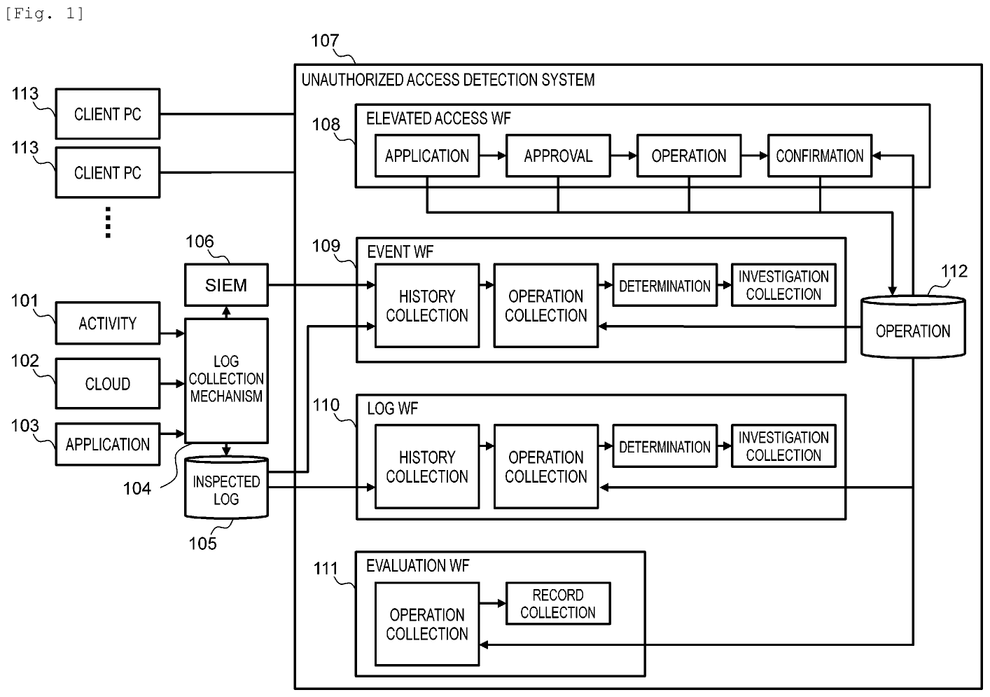

FIG. 1 is a diagram illustrating an overall configuration of a system including an unauthorized access detection device according to an embodiment of the present invention.

In the present embodiment, an operation log is generated from a system user operation (operation of a user on the system) such as a user account activity 101 (an operation in a cloud environment for example), a cloud service 102 (an operation in a cloud computing service on the cloud environment for example), or a user application 103 (an operation in an application for example). The operation log generated is collected by a log collection mechanism 104. The log collection mechanism 104 may be a function in the system on which the operation is performed, or a function provided in a system provided external to a plurality of systems that may be operated. The log collection mechanism 104 stores the collected operation log in an inspected log storage device 105, and/or transmits the collected operation log to a Security Information and Event Management (SIEM) 106. The SIEM detects a security event in real time, based on the operation log. The SIEM is an example of a system that detects a security event. The inspected log storage device 105 is a storage device that stores an inspected log that is an operation log as an inspection target.

An unauthorized access detection device 107 (server for example) is established. The unauthorized access detection device 107 may be referred to as an operation automation system. The unauthorized access detection device 107 executes processes in accordance with a workflow defined. In the present embodiment, the “workflow” is a program in which a processing order is defined, and a process as a program is called based on the processing executed. Examples of the workflow include an elevated access workflow 108, an event workflow 109, a log workflow 110, and an evaluation workflow 111.

When the unauthorized access detection device 107 executes a workflow, operation data and execution results of each process are generated and stored. Specifically, for example, in the elevated access workflow 108, operation data and execution results of each process are stored in an operation table 112. In the event workflow 109 and the log workflow 110, data is read from the inspected log storage device 105 and the operation table 112, and whether a response is required for an incident is determined. In the evaluation workflow 111, data is read from the operation table 112, an access authority record is evaluated, and a result of the evaluation is output.

One or a plurality of client PCs 113 are communicably connected to the unauthorized access detection device 107 (“PC” is short for personal computer). The client PC 113 is used, for example, by a member (hereinafter, referred to as an operating user) of a system operating team or a member (hereinafter, referred to as a security user) of a security team. Each of the operating user and the security user uses the client PC 113 to access the unauthorized access detection device 107.

The “system operating team” is a team in charge of system operation. The operating user is a user that may perform any of system user operations 101 to 103. The operating user may perform the system user operation using the client PC 113. The “security team” is a team in charge of responses to detected unauthorized accesses.

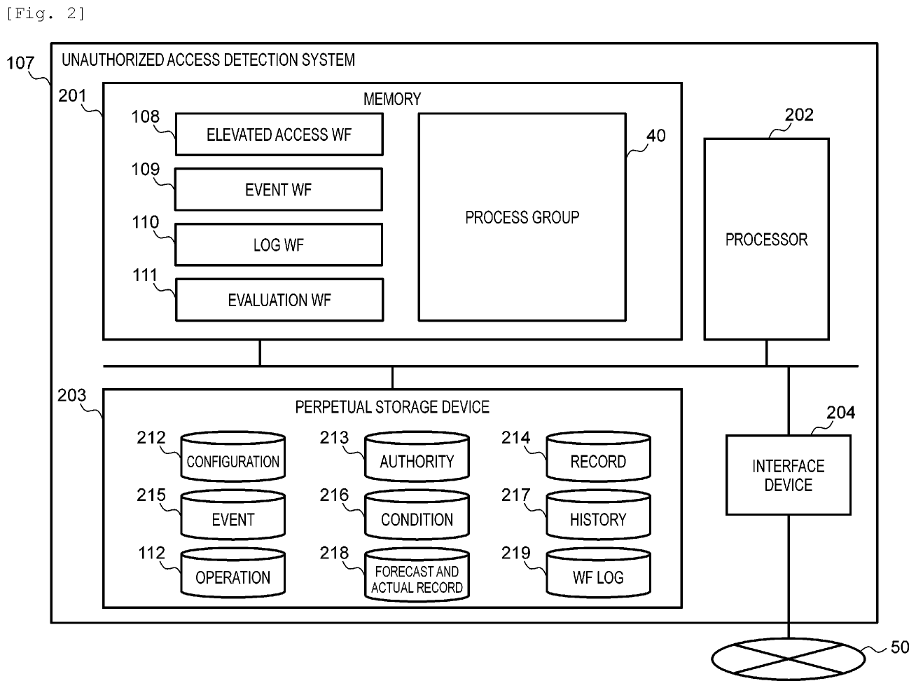

FIG. 2 is a diagram illustrating a configuration of the unauthorized access detection device 107.

The unauthorized access detection device 107 includes a memory 201, a perpetual storage device 203, and an interface device 204, as well as a processor 202 connected to these.

Data from the inspected log storage device 105 and the SIEM 106 and data input to and output from the client PC 113 (over a Web browser for example) passes through the interface device 204 and a communication network 50.

The memory 201 stores the elevated access workflow 108, the event workflow 109, the log workflow 110, the evaluation workflow 111, and a process group 40 (a plurality of processes). These workflows 108 to 111 and the process group 40 are executed by the processor 202. Each process in the process group 40 is called in a workflow associated with the process.

The perpetual storage device 203 stores a configuration table 212, an authority table 213, a record table 214, an event table 215, a condition table 216, a history table 217, an operation table 112, an forecast and actual record table 218, and a workflow log table 219.

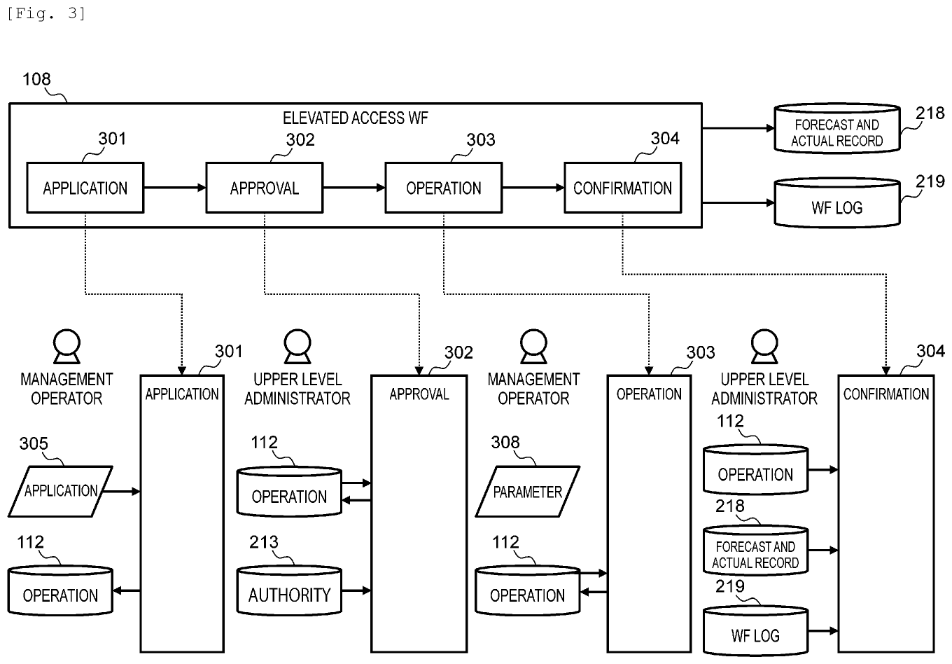

FIG. 3 is a schematic view of the elevated access workflow. In the description with reference to FIG. 3, a management operator and an upper level administrator each input and output data using the client PC 113. The management operator may be an operating user. The upper level administrator may be another operating user, a security user, or another type of user. The correspondence relationship between the management operator and the upper level administrator may be identified from a table not illustrated.

The elevated access workflow 108 represents a flow related to temporary elevation of access authority. The elevated access workflow 108 is associated with an operation application process 301, an upper level administrator approval process 302, a management operation process 303, and an upper level administrator confirmation process 304. In the elevated access workflow 108, these processes are called as appropriate. When the elevated access workflow 108 is executed, data is input to and output from the forecast and actual record table 218 and the workflow log table 219 as appropriate.

The operation application process 301 is called when an operation application is received from the management operator in the elevated access workflow 108. In the operation application process 301, operation application data 305 input from the management operator is received. The operation application data 305 is data indicating an operation application, and includes, for example, data indicating the content of an operation of an application target (for example, system names of an access source, an access destination, and a system including the access destination). In the operation application process 301, data in the operation application data is stored in the operation table 112.

The upper level administrator approval process 302 is called when the operation application process 301 ends for example. In the upper level administrator approval process 302, the operation application indicated by the data stored in the operation table 112 is provided to the upper level administrator. In the upper level administrator approval process 302, when the upper level administrator approves the operation application provided, a reference is made on the authority table 213 using, as a key, an action identified from the operation application, and data (for example, a role name or a policy name) related to the access authority required for executing the action is provided to the upper level administrator. In the upper level administrator approval process 302, set authority data determined by the upper level administrator based on the provided data, is received from the upper level administrator. The set authority data is data indicating the access authority (set target) permitted for the operation application, and includes data indicating a role name, a valid period, and a ticket ID for example. In the level administrator approval process 302, the set authority data is stored in the operation table 112. Information indicating that the operation application has been approved in the upper level administrator approval process 302 may be provided to the management operator in the upper level administrator approval process 302.

The management operation process 303 is called when the upper level administrator approval process 302 ends with the operation application approved for example. In the management operation process 303, parameter data 308 required for the management operation input from the management operator is received, the management operation is executed based on an operation by the management operator, and operation completion is registered in the operation table 112.

The upper level administrator confirmation process 304 is called when the management operation process 303 ends for example. In the upper level administrator confirmation process 304, data is read from the operation table 112, the forecast and actual record table 218, and the workflow log table 219, and the read data is provided to the upper level administrator. In the upper level administrator confirmation process 304, confirmation of the execution result is received from the upper level administrator, and whether the temporarily elevated access authority is invalidated is confirmed. For example, when the operation completion is registered in the operation table 112 in the management operation process 303, the invalidation of the temporarily elevated access authority may be registered in the authority table 213 in the management operation process 303 or the upper level administrator confirmation process 304. Then, the invalidation may be confirmed in the upper level administrator confirmation process 304.

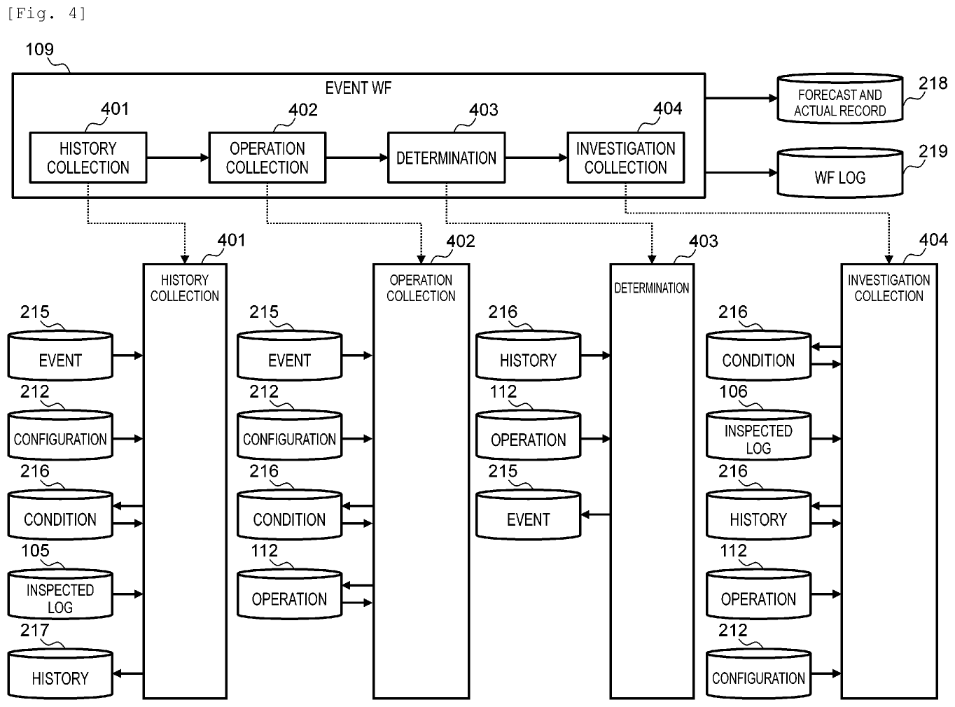

FIG. 4 is a schematic view of an event workflow.

The event workflow 109 represents a flow related to the determination of the validity of the security event. The event workflow 109 is associated with a history collection process 401, an operation collection process 402, a determination process 403, and an investigation collection process 404. In the event workflow 109, these processes are called as appropriate. When the event workflow 109 is executed, data is input to and output from the forecast and actual record table 218 and the workflow log table 219 as appropriate. The event workflow 109 may start each time the SIEM 106 detects a security event and data indicating the security event is stored in the event table 215 for example.

The history collection process 401 is called when the event workflow 109 starts for example. In the history collection process 401, data is read from the event table 215 and the configuration table 212, a filtering condition for the operation log is determined based on such data, and the determined filtering condition is set to the condition table 216. The filtering condition for the operation log may be set in advance. In the history collection process 401, the operation log satisfying the filtering condition set to the condition table 216 is collected from the inspected log storage device 105, and the collected operation log is stored in the history table 217. The stored operation log is an operation log corresponding to the operation leading to the security event. Thus, in the present embodiment, each security event corresponds to one or more operation logs.

The operation collection process 402 is called when the history collection process 401 ends (or in parallel with the history collection process 401). In the operation collection process 402, data is read from the event table 215 and the configuration table 212, and a filtering condition for the elevated access operation is set based on such data. The determined filtering condition is set to the condition table 216. The “elevated access operation” is an operation performed by the management operator (operating user) when the elevated access workflow 108 is executed (access operation as an operation within a range of the temporarily elevated access authority). The filtering condition for the elevated access operation may be set in advance. In the operation collection process 402, operation data indicating the elevated access operation satisfying the filtering condition set to the condition table 216 is identified in the operation table 112.

The determination process 403 is called when the history collection process 401 and the operation collection process 402 end. In the determination process 403, response requirement determination processing is executed including comparison between the operation log (operation log corresponding to the security event) stored in the history table 217 in the history collection process 401, and the operation data identified in the operation table 112 in the operation collection process 402. In the determination process 403, the result of the processing is registered in the event table 215 (the result is associated with the security event corresponding to the operation log).

The investigation collection process 404 is called, for example, when a result of the determination in the determination process 403 indicates that the security event corresponding to the operation log indicates an unauthorized access or is caused by an unauthorized access. In the investigation collection process 404, data is read from the history table 217, the operation table 112, d the configuration table 212, a filtering condition for the operation log to be the inspection target is determined based on such data, and the determined filtering condition is set to the condition table 216. In the investigation collection process 404, the operation log satisfying the filtering condition set to the condition table 216 is collected from the inspected log storage device 105, and the collected operation log is stored in the history table 217.

FIG. 5 is a schematic view of a log workflow.

The log workflow 110 represents a flow for determining validity of the inspected log. The log workflow 110 is associated with the history collection process 501, the operation collection process 502, the determination process 403, and the investigation collection process 404. In the log workflow 110, these processes are called as appropriate. When the log workflow 110 is executed, data is input to and output from the forecast and actual record table 218 and the workflow log table 219 as appropriate. The log workflow 110 may start periodically, or each time a certain amount of operations logs are stored in the inspected log storage device 105 after the execution of the immediately preceding log workflow 110.

The history collection process 501 is called when the log workflow 110 starts for example. In the history collection process 501, a review target (for example, data indicating an operation range and an operation execution period related to an operation log) 505 is acquired. The review target 505 may be data registered in advance. In the history collection process 501, a filtering condition for the operation log is determined based on the review target 505 and the data in the configuration table 212, and the determined filtering condition is set to the condition table 216. The filtering condition for the operation log may be set in advance. In the history collection process 501, an operation log satisfying the filtering condition set to the condition table 216 is collected from the inspected log storage device 105, and the collected operation log is stored in the history table 217.

The operation collection process 502 is called, for example, when the history collection process 501 ends (or in parallel with the history collection process 501). In the operation collection process 502, a filtering condition for the elevated access operation is determined based on the review target 505 and data in the configuration table 212, and the determined filtering condition is set to the condition table 216. The filtering condition for the elevated access operation may be set in advance. In the operation collection process 502, operation data indicating the elevated access operation satisfying the filtering condition set to the condition table 216 is identified in the operation table 112.

The determination process 403 is called when the history collection process 501 and the operation collection process 502 end for example. The investigation collection process 404 is called when the result of the determination in the determination process 403 indicates that an unauthorized access is identified from the collected operation log. The processing executed in the determination process 403 and the investigation collection process 404 is the same as the processing described with reference to FIG. 4.

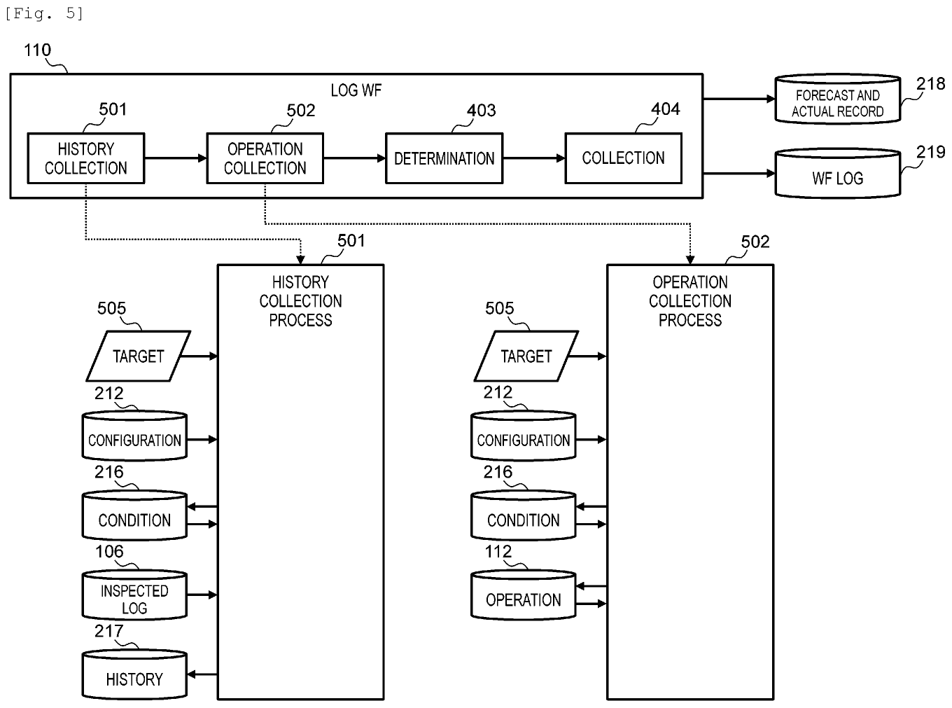

FIG. 6 is a schematic view of an evaluation workflow.

The evaluation workflow 111 represents a flow related to evaluation of the access authority record. The evaluation workflow 111 is associated with the operation collection process 502 and the record collection process 601. In the evaluation workflow 111, these processes are called as appropriate. When the evaluation workflow 111 is executed, data is input to and output from the forecast and actual record table 218 and the workflow log table 219 as appropriate. The evaluation workflow 111 may start periodically.

For example, the operation collection process 502 is called when the evaluation workflow 111 starts.

The record collection process 601 is called when the operation collection process 502 ends. In the record collection process 601, a data filtering condition is determined based on data in the operation table 112, and the determined filtering condition is set to the condition table 216. In the record collection process 601, data satisfying the filtering condition set to the condition table 216 is read from the forecast and actual record table 218 and the workflow log table 219, a record is identified from the read data, and the data indicating the identified record is stored in the record table 214.

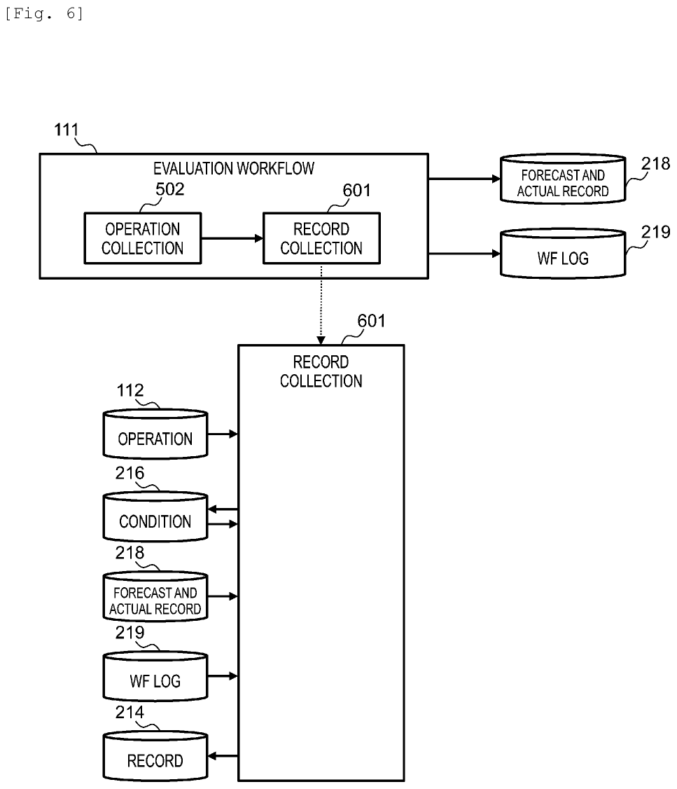

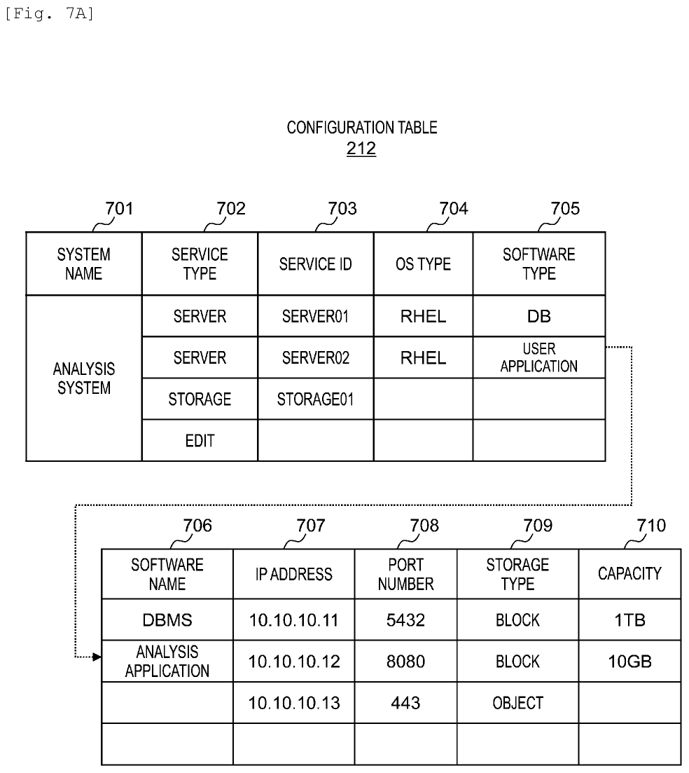

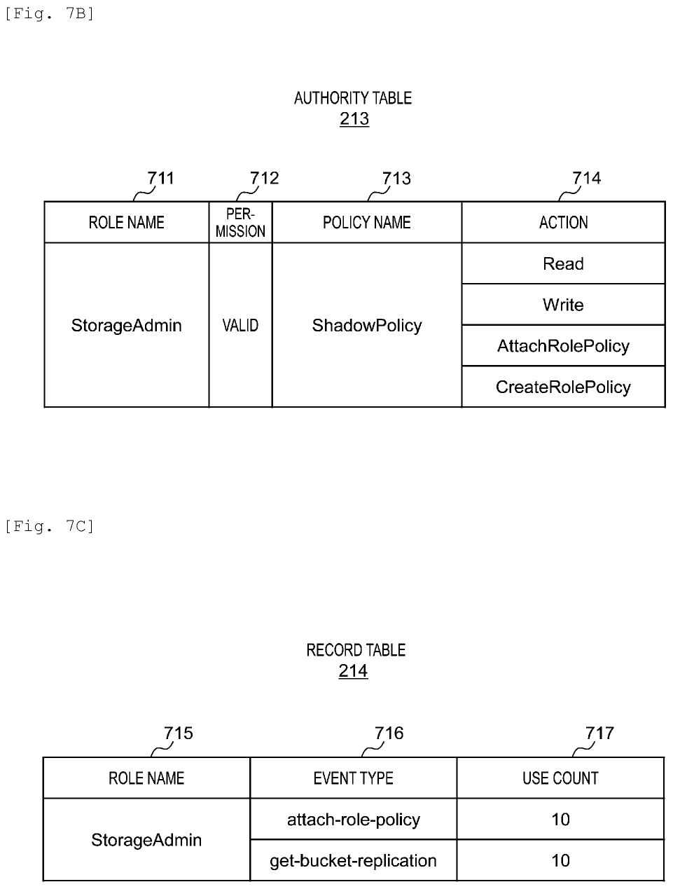

FIG. 7A is a diagram illustrating a configuration of the configuration table 212.

The configuration table 212 indicates a configuration of each system that is a potential target of the system user operation. The configuration table 212 includes a record for each system that is a potential target of the system user operation. The record includes information such as a system name 701, and includes a sub record for each service of the system. The sub record includes information such as a service type 702, a service ID 703, an OS type 704, a software type 705, a software name 706, an IP address 707, a port number 708, a storage type 709, and a capacity 710. In the present embodiment, the system that is a potential target of the system user operation may be a system in a cloud environment, and the service in the system may be a cloud computing service.

The system name 701 indicates the name of a system. The service type 702 indicates the name of the type of the service. The service ID 703 indicates the ID of the service. The OS type 704 indicates the type of the OS of the software providing the service. The software type 705 indicates the type of the software that provides the service. The software name 706 indicates the name of the software that provides the service. The IP address 707 indicates the IP address of the service. The port number 708 indicates the port number of the service. The storage type 709 indicates the type of the storage provided by the service. The capacity 710 indicates the capacity of the storage provided by the service.

FIG. 7B is a diagram illustrating a configuration of the authority table 213.

The authority table 213 indicates whether each of a plurality of access authorities is valid or invalid. The authority table 213 includes a record for each access authority. The record includes information such as a role name 711, permission 712, a policy name 713, and an action 714.

The role name 711 indicates the name of a role as access authority. The permission 712 indicates whether the access authority is valid or invalid. The policy name 713 indicates the name of the policy of the access authority. There may be a plurality of policies for a single role, and the access authority may include a role name and any of the plurality of policy names corresponding to the role name. The action 714 indicates one or a plurality of actions associated with the policy.

When the permission 712 for access authority is “valid”, each action defined in the action 714 for the access authority is a valid action (operation). The “policy” may correspond to a group of one or more actions defined. FIG. 7C is a diagram illustrating a configuration of the record table 214.

The record table 214 indicates a use record for each access authority. The record table 214 includes a record for each access authority. The record includes information such as a role name 715, an event type 716, and a use count 717.

The role name 715 indicates the name of a role as access authority. The event type 716 indicates the type of a security event. The use count 717 indicates a security event detection count. In the present embodiment, an action belonging to the access authority corresponds to the security event. Thus, the count indicated by the use count 717 associated with the security event corresponds to the execution count of actions corresponding to the security event.

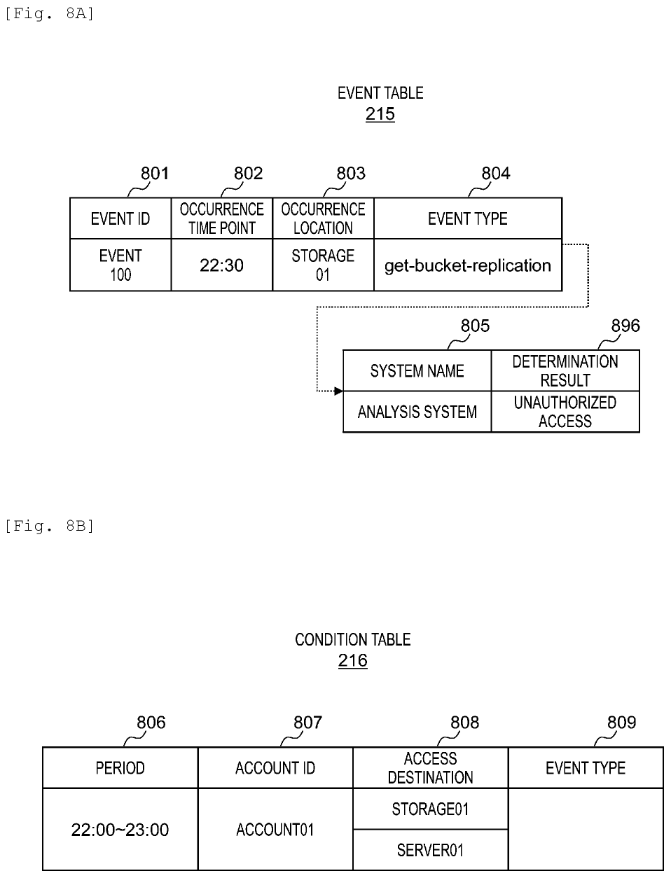

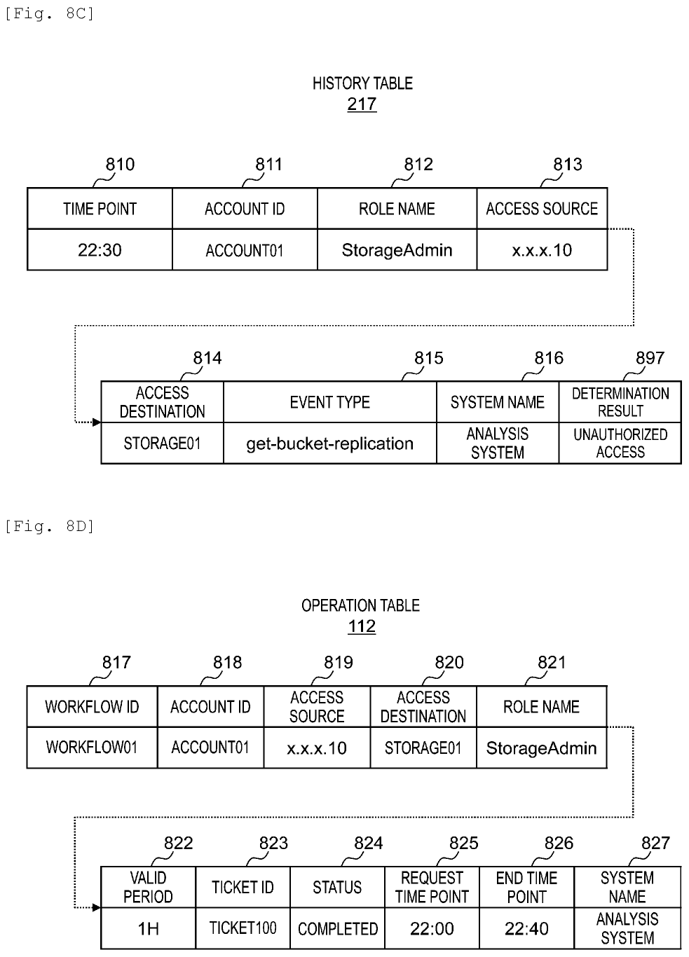

FIG. 8A is a diagram illustrating a configuration of the event table 215.

The event table 215 indicates a security event. The event table 215 includes a record for each security event. The record includes information such as an event ID 801, an occurrence time point 802, an occurrence location 803, an event type 804, a system name 805, and a determination result 896.

The event ID 801 indicates the ID of a security event. The occurrence time point 802 indicates a time point at which the security event has occurred. The occurrence location 803 indicates a location (an element in a system (such as a service) for example) where the security event has occurred. The event type 804 indicates the type of the security event. The system name 805 indicates the name of the system including the location where the security event has occurred. The determination result 896 indicates a result of the determination on whether a response is required (whether the security event is a security incident as an unauthorized access, or a security incident caused by an unauthorized access).

FIG. 8B is a diagram illustrating a configuration of the condition table 216.

The condition table 216 indicates a filtering condition. The condition table 216 includes a record for each filtering condition. The record includes information such as a period 806, an account ID 807, an access destination 808, and an event type 809.

The period 806 indicates a period. The account ID 807 indicates an ID of an account (typically, an operating user). The access destination 808 indicates an access destination (a service in the system for example). The event type 809 indicates the type of the security event.

FIG. 8C is a diagram illustrating a configuration of the history table 217.

The history table 217 indicates an operation history. The history table 217 includes a record for each operation log. The record includes part or the entirety of the operation log. The record includes information such as a time point 810, an account ID 811, a role name 812, an access source 813, an access destination 814, an event type 815, a system name 816, and a determination result 897.

The time point 810 indicates a time point (a time point at which the operation is performed) indicated by the operation log. The account ID 811 indicates an ID of an account (a user that has performed the operation (typically, an operating user)) indicated by the operation log. The role name 812 indicates the role name (the name of the role assigned to the account indicated by the operation log) indicated by the operation log. The access source 813 indicates the access source indicated by the operation log (the IP address corresponding to the account (user) for example). The access destination 814 indicates the access destination (a service on which the operation has been performed for example) indicated by the operation log. The event type 815 indicates the type of the security event corresponding to the operation indicated by the operation log. The system name 816 indicates the name of the system on which the operation is performed. The determination result 897 indicates the result of the determination on whether a response is required (whether the security event corresponding to the operation log is a security incident as an unauthorized access, or a security incident caused by the unauthorized access).

FIG. 8D is a diagram illustrating a configuration of the elevated access operation table.

The operation table 112 indicates an elevated access operation. The operation table 112 includes a record for each execution of the elevated access workflow 108. The record includes information such as a workflow ID 817, an account ID 818, an access source 819, an access destination 820, a role name 821, a valid period 822, a ticket ID 823, a status 824, a request time point 825, an end time point 826, and a system name 827.

The workflow ID 817 indicates an ID corresponding to the elevated access workflow 108 (or the execution of the same). The account ID 818 indicates the ID of a user that has performed the elevated access operation. The access source 819 indicates the access source (the IP address corresponding to the user for example). The access destination 820 indicates a service on which the elevated access operation has been performed. The role name 821 indicates the role name assigned to the user. The valid period 822 indicates a valid period (a valid period from the time point indicated by the request time point 825) of the elevated access operation. The ticket ID 823 indicates the ID of a ticket (a permission certificate of the elevated access operation for example) of the elevated access operation. The status 824 indicates the status of the elevated access operation. The request time point 825 indicates a time point at which the operation application for the elevated access operation has been made. The end time point 826 indicates an end time point of the elevated access operation. The system name 827 indicates the name of the system on which the elevated access operation has been performed.

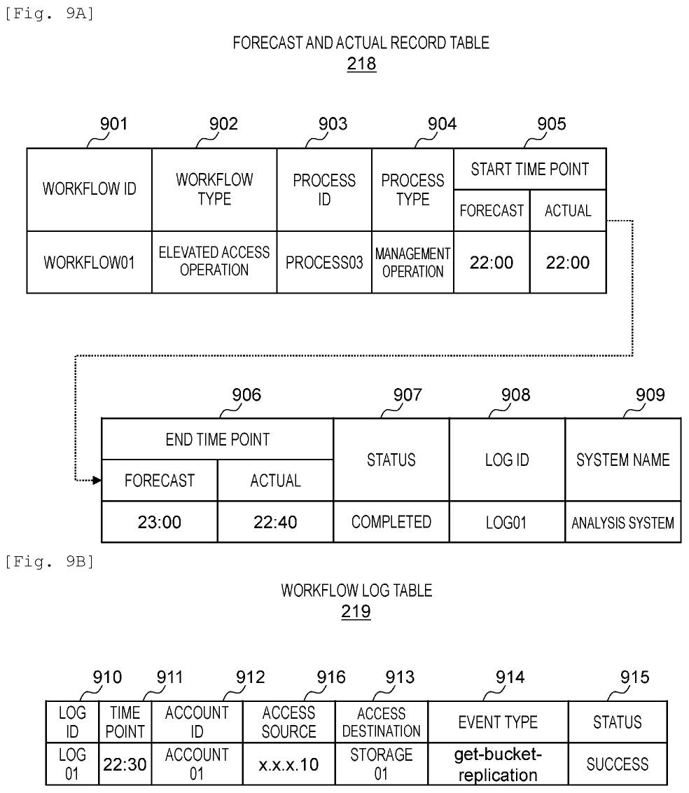

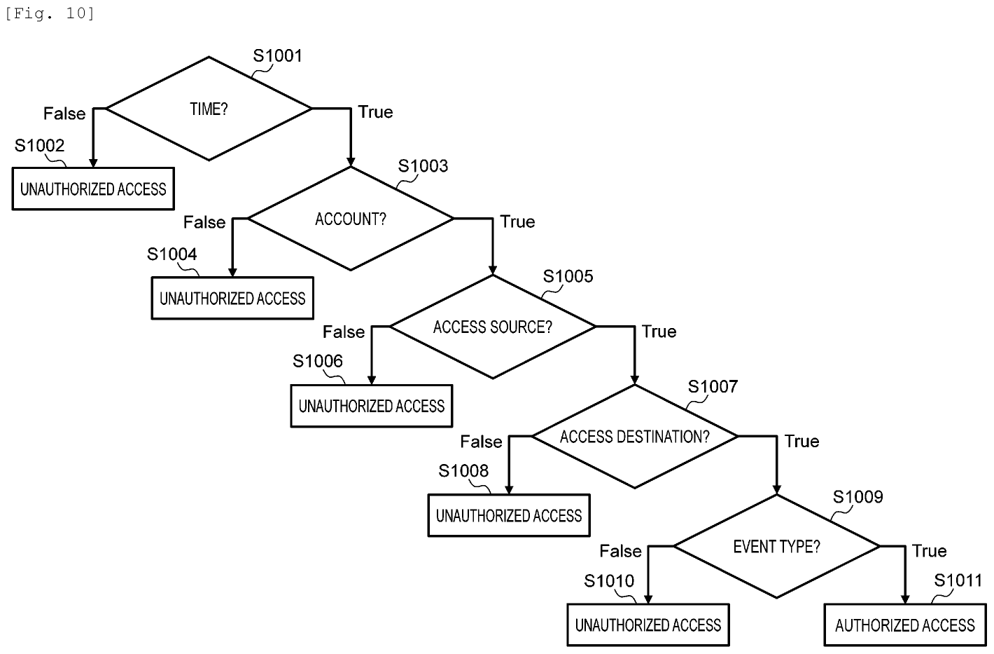

FIG. 9A is a diagram illustrating a configuration of the forecast and actual record table 218.

The forecast and actual record table 218 indicates forecast and actual records for a workflow. The forecast and actual record table 218 includes a record for each process in the workflow. The record includes information such as a workflow ID 901, a workflow type 902, a process ID 903, a process type 904, a start time point 905, an end time point 906, a status 907, a log ID 908, and a system name 909.

The workflow ID 901 indicates the ID of a workflow (or execution of the same). The workflow type 902 indicates the type of the workflow. The process ID 903 indicates the ID of a process. The process type 904 indicates the type of the process. The start time point 905 indicates a forecasted start time point and a recorded start time point (actual start time point) of the process. The end time point 906 indicates the forecasted end time point and the recorded end time point (actual end time point) of the process. The status 907 indicates the status of the process. The log ID 908 indicates the ID of a workflow log. The system name 909 indicates the name of a system related to the workflow.

FIG. 9B is a diagram illustrating a configuration of the workflow log table 219.

The workflow log table 219 indicates a workflow log. The workflow log table 219 includes a record for each workflow log. The record includes information such as a log ID 910, a time point 911, an account ID 912, an access source 916, an access destination 913, an event type 914, and a status 915.

The log ID 910 indicates an ID of a workflow log. The time point 911 indicates a time point at which the workflow log has been acquired. The account ID 912 indicates an ID of an account (user) corresponding to the workflow log. The access source 916 indicates an access source (an IP address corresponding to the user for example). The access destination 913 indicates the access destination corresponding to the workflow log. The event type 914 indicates the type of the security event corresponding to the workflow log. The status 915 indicates a status of a process or workflow corresponding to the workflow log.

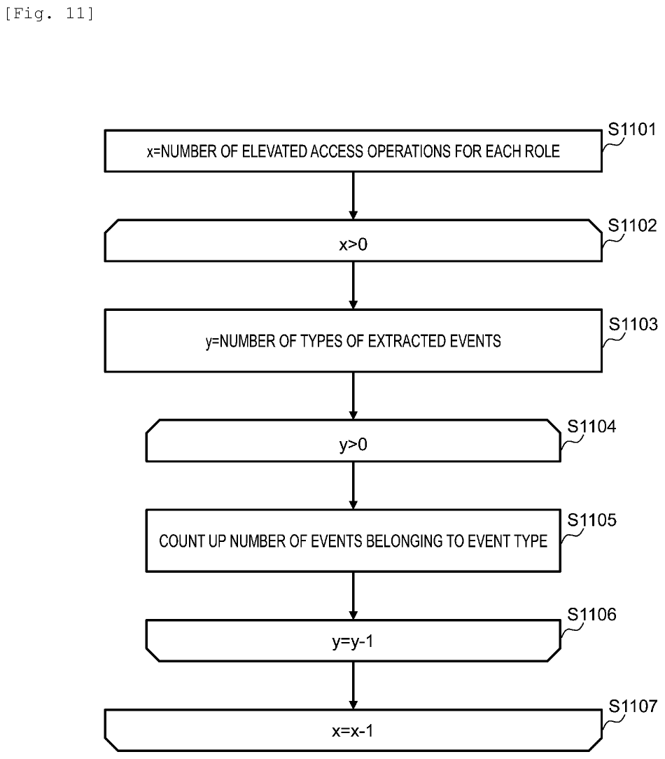

FIG. 10 is a flowchart illustrating response requirement determination processing.

In the determination process 403, whether the operation history (a time period indicated by the time point 810 in one or more operation logs) corresponds to the valid period 822 of the elevated access operation (S1001). When the result of the determination in S1001 is False, in the determination process 403, the operation log belonging to the operation history is determined to be an unauthorized access, or a security event corresponding to the operation log is determined to be an unauthorized access (S1002).

When the result of the determination in S1001 is True, in the determination process 403, whether the operation history (account ID 810 of one or more operation logs) corresponds to the account ID 818 of the elevated access operation is determined (S1003). When the result of the determination in S1003 is False, the same determination result as in S1002 is made in the determination process 403 (S1004).

When the result of the determination in S1003 is True, in the determination process 403, whether the operation history (access source 813 of one or more operation logs) corresponds to the access source 819 of the elevated access operation is determined (S1005). When the result of the determination is False, the same determination result as in S1002 is made in the determination process 403 (S1006).

When the result of the determination in S1005 is True, in the determination process 403, whether the operation history (the access destination 814 of one or more operation logs) corresponds to the access destination 820 of the elevated access operation is determined (S1007). When the result of the determination is False in S1007, the same determination result: as in S1002 is made in the determination process 403 (S1008).

When the result of the determination in S1007 is True, in the determination process 403, whether the operation history (the event type 815 of one or more operation logs) corresponds to the event type of the elevated access operation (specifically, the event type 914 identified using the log ID 908 corresponding to the elevated access operation) (S1009). When the result of the determination is False in S1009, the same determination result as in S1002 is made in the determination process 403 (S1010).

When the result of the determination in S1009 is True, in the determination process 403, the operation log belonging to the operation history is determined to be an authorized access, or the security event corresponding to the operation log is determined to be an authorized access (S1011).

The order of the determinations S1001, S1003, S1005, S1007, and S1009 is not limited to the order illustrated in FIG. 10.

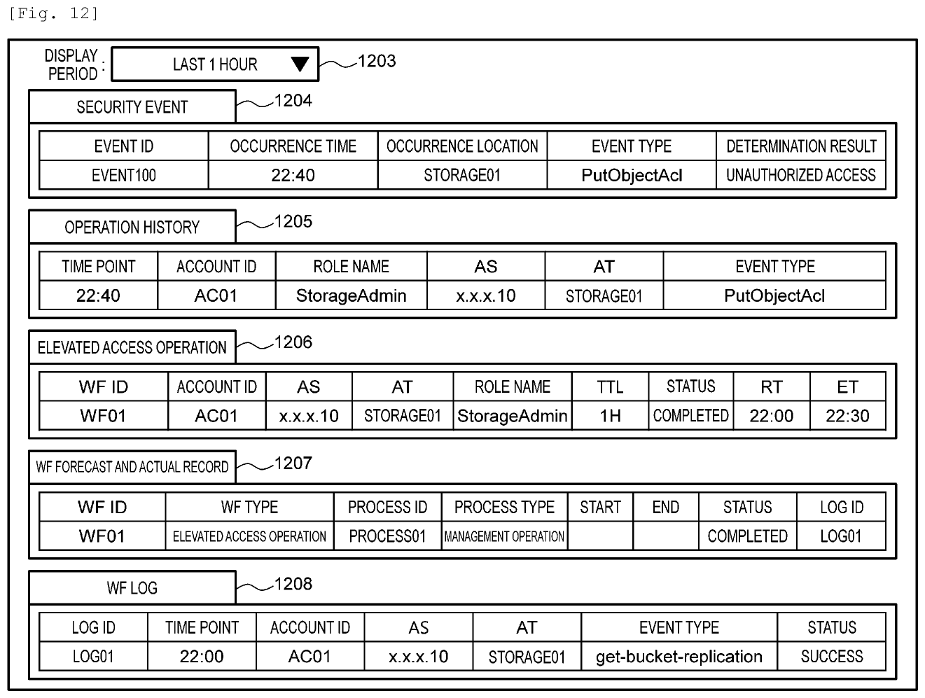

FIG. 11 is a flowchart of use record collection processing.

The use record collection processing is executed in the evaluation workflow 111. In the evaluation workflow 111, the number of elevated access operations for each role is substituted into x (S1101). The “number of elevated access operations for each role” is the number of roles of the elevated access operations (roles identified from the operation table 112). In the evaluation workflow 111, the processing in S1103 to S1107 is repeated as long as x is larger than 0 (S1102). In other words, the processing in S1103 to S1107 is executed for each role in the elevated access operation.

In the evaluation workflow 111, an event corresponding to the workflow log in the elevated access workflow 108 is extracted, and the number of types of the extracted event is substituted into y (S1103). In the evaluation workflow 111, the processing in S1105 and S1106 is repeated as long y is large than 0 (S1104). In other words, the processing in S1105 and S1106 is executed for each event type for one role in the elevated access operation.

In the evaluation workflow 111, the number of events belonging to the event type is counted up (S1105). In the evaluation workflow 111, y is decremented (S1106).

When S1106 results in y=0, in the evaluation workflow 111, x is decremented (S1107).

When S1107 results in x=0, the processing ends.

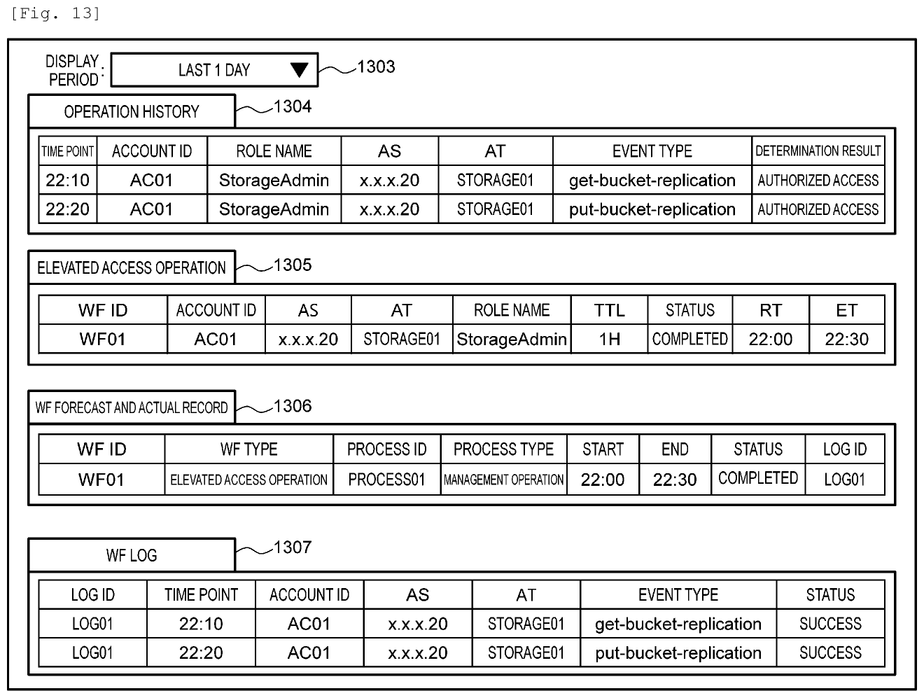

Examples of some display screens are explained below with reference to FIG. 12 to FIG. 14. While the following abbreviations are used in FIG. 12 to FIG. 14 because of space limitations, both an abbreviation and an official name may be displayed on an actual screen.
access source→AS (stands for Access Source)
access destination→AT (stands for Access Target)
valid period→TTL (stands for Time To Live)
request time point→RT (stands for Request Time)
end time point→ET (stands for End Time)

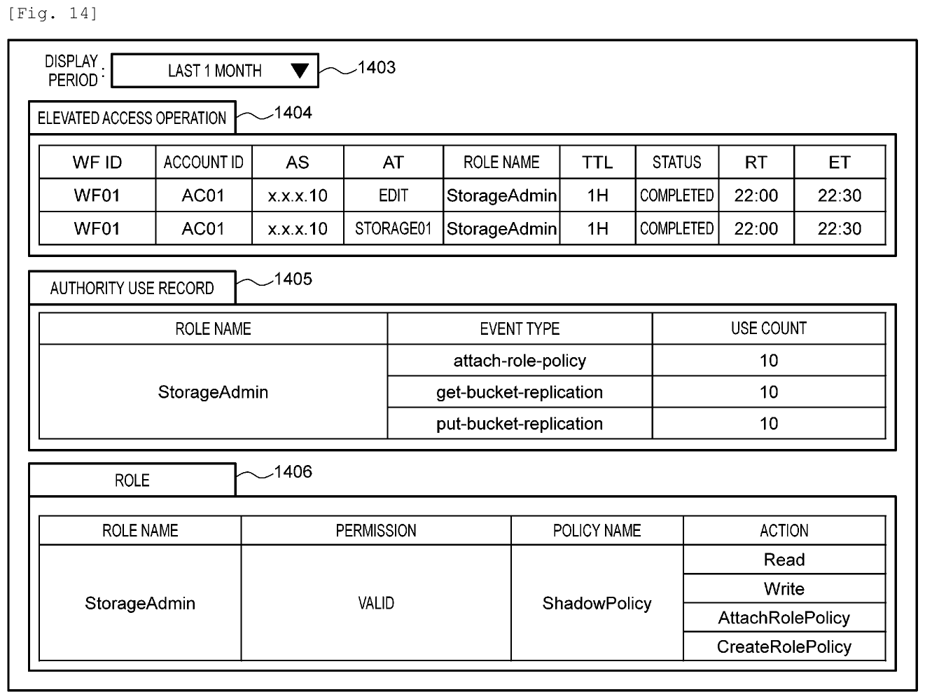

FIG. 12 is a schematic view of a security event screen. For example, on the screen in FIG. 12 and FIG. 13, a system name is designated by the user, and information related to the designated system name is displayed.

The security event screen is displayed on the client PC 113 (the client PC 113 of the security user for example) in the event workflow 109.

In the event workflow 109, information indicated by data belonging to a period, input in a display period 1203, is displayed on the security event screen.

Information displayed in a security event area 1204 is based on the event table 215. According to the example illustrated, an event 100 that is “PutObjectAcl” occurred at 22:40.

Information displayed in an operation history area 1205 is based on the history table 217 (the same applies to FIG. 13). According to the illustrated example, StorageAdmin of AC01 performed the “PutObjectAcl” operation at 22:40.

Information displayed in an elevated access operation area 1206 is based on the operation table 112 (the same applies to FIG. 13 and FIG. 14). According to the illustrated example, StorageAdmin of AC01 performed an operation on storage 01 from 22:00 to 22:30.

Information displayed in a workflow forecast and actual record area 1207 is based on the forecast and actual record table 218 (the same applies to FIG. 13 and FIG. 14). Information displayed in a workflow log area 1208 is based on the workflow log table 219 (the same applies to FIG. 13 and FIG. 14). According to the illustrated example, a log ID “log 01” corresponding to a workflow ID “workflow 01” of the elevated access operation is acquired, AC01 has successfully executed get-bucket-replication (acquisition of replication setting information) on the storage 01, from the log ID “log 01”.

In the illustrated example, the security event occurred at the time point 22:40 outside the time period from 22:00 to 22:30 in which the elevated access operation was performed, the result in S1001 is False, and the security event is determined to be an unauthorized access.

FIG. 13 is a schematic view of an inspected log screen.

The inspected log screen is displayed on the client PC 113 (the client PC 113 of the security user for example) in the log workflow 110.

In the log workflow 110, information indicated by data belonging the period input to a display period 1303 is displayed on the inspected log screen.

Regarding an operation history area 1304, according to the illustrated example, StorageAdmin (AS“x.x.x.20”) of AC01 performed, on the storage 01, “get-bucket-replication (acquisition of replication setting information)” at 22:10 and “put-bucket-replication (execution of replication setting)” at 22:20.

Regarding an elevated access operation area 1305 according to the illustrated example, in WF01, the StorageAdnin (AS“x.x.x.20”) of AC01 performed the operation from 22:00 to 22:30.

Regarding a workflow forecast and actual record area 1306 and a workflow log area 1307, according to the illustrated example, the StorageAdmin (AS“x.x.x.20”) of AC01 executed put-bucket-replication (replication setting) after the get-bucket-replication (acquisition of replication setting information) on the storage 01.

According to the illustrated example, the results in each of S1001, S1003, S1005, S1007, and S1009 are True due to the following reasons, and the operation is determined to be an authorized access.
Each of operation time points 22:10 and 22:20 is within the time period from 22:00 to 22:30 of the elevated access operation.
The account ID is the same between the operation history and the elevated access operation.
The access source is the same between the operation history and the elevated access operation.
The access destination is the same between the operation history and the elevated access operation.
The event type is the same between the operation history and the elevated access operation.

FIG. 14 is a schematic view of an access authority screen.

The access authority screen is displayed on the client PC 113 (the client PC 113 of the security user for example) in the evaluation workflow 111.

In the evaluation workflow 111, information indicated by data belonging the period input to a display period 1403 is displayed on the access authority screen.

Regarding an elevated access operation area 1404, in the illustrated example, elevated access operations of the same role name are listed for example.

Information displayed on an authority use record area 1405 is based on the result of the use record collection processing, that is, the result of the event type aggregation performed for each role. According to the illustrated example, each of the event types “attach-role-policy (policy application to a role)”, “get-bucket-replication (acquisition of replication setting information)”, and “put-bucket-replication (execution of replication setting)” is performed 10 times for the role name “StorageAdmin”.

The information displayed in a role area 1406 is based on the authority table 213. According to the illustrated example, “CreateRolePolicy (creation of a new policy)” among actions assigned to the role name “StorageAdmin” is not used. Thus, the user such as the security user and the upper level administrator can continuously make a record-based improvement, regarding whether the access authority needs to be changed to minimize the actions assigned to the role name “StorageAdmin” and the like.

While an embodiment has been described above, this is provided for an illustrative purpose only and not intended to limit the scope of the present invention to this embodiment. The present invention can be practiced in various other modes.

The embodiments described above can be outlined as follows. The outline below may include a supplemental description for the description above and a description of modifications.

The unauthorized access detection device 107 includes the interface device 204, the storage device (the memory 201 and the perpetual storage device 203 for example), and the processor 202 connected to the interface device 204 and the storage device. The unauthorized access detection device 107 may be a physical computer system (one or more physical computers) or may be a logical computer system based on the physical computer system.

The interface device 204 is communicably connected to an operation log source (the inspected log storage device 105 for example). The operation log source is a source of an operation log for an operation performed by the user on an operation target system (an analysis system provided in a cloud environment for example).

The processor 202 is configured to store, in the storage device, elevated access management data that is data related to an elevated access operation performed on the operation target system. The elevated access operation is an operation within a range of temporarily elevated access authority. The elevated access management data may include, for the elevated access operation, a record in the operation table 112, a record in the forecast and actual record table 218, and a record in the workflow log table 219. The user assigned with the temporarily elevated access authority may be referred to as “shadow administrator” for example.

The operation log source is configured to accumulate operation logs of operations as the elevated access operation on the operation target system, as well as operation logs of operations other than the elevated access operation.

The processor 202 acquires an operation history that is one or more operation logs from the operation log source, and stores the operation history in the storage device. The processor 202 acquires the elevated access management data from the storage device. The processor 202 performs determination on whether a response is required. The determination on whether a response is required is a determination on whether an operation identified from the operation history is an operation as an unauthorized access not matching an operation identified from the elevated access management data. The processor 202 provides a result of the determination on whether a response is required (provided to an information processing terminal of the user through the interface device 204 for example).

With the determination on whether a response is required thus made using the elevated access management data for the operation history, a risk of detecting an access (access operation) within a range of the temporarily elevated access authority as an unauthorized access can be reduced. Instead of or in addition to the response requirement determination processing illustrated in FIG. 10, the processor 202 (in the elevated access workflow 108 for example) may compare the forecasted (the forecasted time point of the start time point 905 and the forecasted time point of the end time point 906) and the actual elevated access operations. When the actual operation satisfies a predetermined condition with respect to the forecasted operation (for example, the actual operation matches the forecasted operation, or a difference between the actual operation and the forecasted operation is within a tolerable range), the processor 202 may store the elevated access management data on the elevated access operation in the storage device. On the other hand, when the actual operation does not satisfy the predetermined condition with respect to the forecasted operation, the processor 202 may not store the elevated access management data on the elevated access operation in the storage device, or invalidate the data. In this case, a result indicating an unauthorized access is expected to be obtained as the result of the determination on whether a response is required, due to the absence of valid elevated access management data corresponding to the operation history.

The elevated access management data includes at least one of data indicating the range of time at which the elevated access operation is performed (for example, the request time point 825 and the end time point 826, and the time point recorded as the start time point 905 and the time point recorded as the end time point 906), the account ID 818 of the user that has performed the elevated access operation, the access source 819 and the access destination 820 indicating the targets of the elevated access operation in the operation target system, and the event type 914 corresponding to the operation as the elevated access operation. Each of the one or more operation logs in the operation history includes at least one of the time point 810 of the operation, the account ID 811 of the user that has performed the operation, the access destination 814 as the operation target in the operation target system, and the event type 815 corresponding to the operation. The determination on whether a response is required may include at least one of comparison between the time indicated by the operation history and a time range indicated by the elevated access management data, comparison between the access source 813 indicated by the operation history and the access source 819 indicated by the elevated access management data, comparison between the access destination 814 indicated by the operation history and the access destination 820 indicated by the elevated access management data, comparison between the account ID 811 indicated by the operation history and the account ID 818 indicated by the elevated access management data, and comparison between the event type 815 indicated by the operation history and the event type 914 indicated by the elevated access management data. The result of the determination on whether a response is required may be a result indicating an unauthorized access in at least one case of: the time indicated by the operation history being time outside the time range (False in S1001 for example), the account IDs not matching (False in S1003 for example), no matching access sources (False in S1005 for example), no matching access destinations (False in S1007 for example), and no matching event types (False in S1009 for example). Thus, reduction in the risk of erroneous detection as the unauthorized access, that is, improvement in the detection accuracy of the unauthorized access can be expected.

The interface device 204 may be communicably connected to an event management system (SIEM 106 for example) that detects a security event in real time. The processor 202 may receive event data that is data indicating the security event detected by the event management system through the interface device 204, and store the event data in the storage device. The processor 202 may acquire, as the operation history, one or more operation logs including the operation log of the operation corresponding to the security event indicated by the event data, from the operation log source. The processor 202 may associate the result of the determination on whether a response is required with the event data in the storage device. With the determination on whether a response is required made for the operation log corresponding to the security event, a large load that may be otherwise imposed for the security team to check with the system operating team when a non-malicious operation by the operations administrator (shadow administrator for example) is detected as the security event can be reduced. This may not be limited to the collaboration between the separate teams, which are the security team and the system operating team. The operation log in the operation history acquired may be an operation log satisfying the first filtering condition. The first filtering condition may be a condition indicating the operation log corresponding to the security event detected (for example, a condition including at least one of a period including the time point of the security event, the account ID corresponding to the security event, the access source (IP address for example) and the access destination (for example, service (specifically, an instance of the service for example)) as the target of the security event), and the event type of the security event). The elevated access management data acquired may be an operation log satisfying the second filtering condition. The second filtering condition may be a condition indicating the elevated access operation associated with the operation log corresponding to the security event detected (for example, a condition including at least one of a period including the time point of the security event, the account ID corresponding to the security event, the access destination as the target of the security event, and the event type of the security event). Each of the first and the second filtering conditions may be dynamically generated by the processor 202 (in the event workflow 109 for example), or may be prepared in advance.

The processor 202 may acquire the operation history from the operation log source periodically, or when a predetermined amount of operation logs or more is accumulated in the operation log source after the operation history has been acquired for the previous determination on whether a response is required. The processor 202 may associate the result of the determination on whether a response is required with the operation log in the storage device. This configuration can reduce the risk of the operation log acquired for the purpose of inspection or the like from the operation log source being erroneously detected as the operation log of the unauthorized access. The operation log in the operation history acquired may be an operation log satisfying a third filtering condition. The third filtering condition may be a condition indicating an operation log suitable for the purpose of the inspection or the like, or an operation log involving a high security risk (for example, a condition including at least one of the period, the account ID, the access destination, and the event type estimated to involve the risk). The elevated access management data acquired may be an operation log satisfying a fourth filtering condition. The fourth filtering condition may be a condition indicating the elevated access operation related to the operation log acquired (for example, a condition including at least one of the period, the account ID, the access destination, and the event type). The third and the fourth filtering conditions may be dynamically generated by the processor 202 (in the log workflow 110 for example), or may be prepared in advance.

The range of the temporarily elevated access authority may include the role assigned and one or a plurality of actions that are associated with the role and each correspond to the event type. The elevated access management data may include data indicating the event type corresponding to the operation as the elevated access operation. The operation log may include data indicating the event to the operation. The processor 202 may (in the evaluation workflow 111 for example) count the number of elevated access operations for each event type 914 from the elevated access management data including the same role name 821 (elevated access management data on one or a plurality of elevated access operations including the same role). The processor 202 may perform comparison between or provision of a use count 717 (the number of elevated access operations counted) for each event type 716 and the action within a range of the temporarily elevated access authority. Thus, for each role assigned in the elevated access operation, the number of execution times of each event type of the actual operation and the access authority of the role are compared for evaluating whether the access authority required for the elevated access operation was appropriate (for example, the lowest required authority), or for supporting such an evaluation. Specifically, for example, the processor 202 may identify the action with the number of elevated access operations being a predetermined value (zero for example) or less when performing the comparison, and provide data indicating the action. The processor 202 may provide a screen (an access authority screen for example) indicating the use count 717 of each event type 716 and an action within a range of the temporarily elevated access authority.

The result of the determination on whether a response is required may be provided by providing a screen. The screen may be a screen that displays information indicating the result of the determination on whether a response is required, information indicating the operation history, and information indicated by the elevated access management data. With this configuration, the user can recognize the result of the determination on whether a response is required and what the result is based on.

The storage device may store a plurality of workflows executed by the processor 202. The plurality of workflows may include the elevated access workflow 108 that is a workflow related to the elevated access operation and a determination workflow (the event workflow 109 or the log workflow 110 for example) that is a workflow associated with the determination on whether a response is required. The processor 202 may be configured to store the elevated access management data in the storage device when executing the elevated access workflow 108. The processor 202 may be configured to acquire and store the operation history, acquire the elevated access management data, perform the determination on whether a response is required, and provide the result of the determination on whether a response is required, when executing the determination workflow. Thus, the workflow for the elevated access operation and the workflow for the determination on whether a response is required can be distinguished.

The operation target system may be a system in a cloud environment, and may be a system including one or a plurality of cloud computing services. For example, in a public cloud environment, an unauthorized access can be made through a plurality of portions and intrusions are becoming more and more sophisticated, complicated security measures with a thorough understanding of systems in the public cloud environment are required. In the embodiments described above, however, reduction in the risk of erroneous detection as an unauthorized access, that is, improvement in the detection accuracy of the unauthorized access can be expected without such a thorough understanding.

### REFERENCE SIGNS LIST

107: unauthorized access detection device

1. An unauthorized access detection device comprising:
an interface device communicably connected to an operation log source;
a storage device; and
a processor connected to the interface device and the storage device, wherein
the operation log source is a source of an operation log for an operation performed by a user on an operation target system,
the processor is configured to store, in the storage device, elevated access management data that is data related to an elevated access operation performed on the operation target system,
the elevated access operation is an operation within a range of temporarily elevated access authority,
the operation log source is configured to accumulate operation logs of operations as the elevated access operation on the operation target system, as well as operation logs of operations other than the elevated access operation,
the processor
acquires an operation history that is one or more operation logs from the operation log source, and stores the operation history in the storage device,
acquires the elevated access management data from the storage device,
performs determination on whether a response is required that is a determination on whether an operation identified from the operation history is an operation as an unauthorized access not matching an operation identified from the elevated access management data, and
provides a result of the determination on whether a response is required.

2. The unauthorized access detection device according to claim 1, wherein
the elevated access management data includes data indicating at least one of a range of time at which the elevated access operation is performed, an account ID of a user that has performed the elevated access operation, an access source and an access destination as targets of the elevated access operation in the operation target system, and an event type corresponding to an operation as the elevated access operation,
each of the one or more operation logs in the operation history includes data indicating at least one of a time point at which an operation is performed, an account ID of a user that has performed the operation, an access destination as an operation target in the operation target system, and an event type corresponding to the operation,
the determination on whether a response is required includes at least one of comparison between a time indicated by the operation history and a time range indicated by the elevated access management data, comparison between an access source indicated by the operation history and an access source indicated by the elevated access management data, comparison between an access destination indicated by the operation history and an access destination indicated by the elevated access management data, comparison between an account ID indicated by the operation history and an account ID indicated by the elevated access management data, and comparison between an event type indicated by the operation history and an event type indicated by the elevated access management data, and
the result of the determination on whether a response is required is a result indicating an unauthorized access in at least one case of: the time indicated by the operation history being time outside the time range, the account IDs not matching, no matching access destinations, and no matching event types.

3. The unauthorized access detection device according to claim 1, wherein
the interface device is communicably connected to an event management system that detects a security event in real time,
the processor
receives event data that is data indicating the security event detected by the event management system through the interface device, and stores the event data in the storage device,
acquires, as the operation history, one or more operation logs including an operation log of an operation corresponding to the security event indicated by the event data, from the operation log source, and
associates the result of the determination on whether a response is required with the event data in the storage device.

4. The unauthorized access detection device according to claim 1, wherein
the processor
acquires an operation history from the operation log source periodically, or when a predetermined amount of operation logs or more is accumulated in the operation log source after an operation history has been acquired for previous determination on whether a response is required, and
associates the result of the determination on whether a response is required with the operation log in the storage device.

5. The unauthorized access detection device according to claim 1, wherein
a range of temporarily elevated access authority includes a role assigned and one or a plurality of actions that are associated with the role and each correspond to an event type,
the elevated access management data includes data indicating an event type corresponding to an operation as the elevated access operation,
an operation log includes data indicating an event type corresponding to an operation,
the processor
counts number of elevated access operations for each event type from the elevated access management data on one or a plurality of elevated access operations including a same role, and
performs comparison between or provision of number of elevated access operations counted for each event type and an action within a range of the temporarily elevated access authority.

6. The unauthorized access detection device according to claim 1, wherein
the result of the determination on whether a response is required is provided by providing a screen, and
the screen is a screen that displays information indicating the result of the determination on whether a response is required, information indicating the operation history, and information indicated by the elevated access management data.

7. The unauthorized access detection device according to claim 1, wherein
the storage device stores a plurality of workflows executed by the processor,
the plurality of workflows include an elevated access workflow that is a workflow related to an elevated access operation and a determination workflow that is a workflow associated with the determination on whether a response is required,
the processor is configured to store the elevated access management data in the storage device when executing the elevated access workflow, and
the processor is configured to acquire and store the operation history, acquire the elevated access management data, perform the determination on whether a response is required, and provide the result of the determination on whether a response is required, when executing the determination workflow.

8. The unauthorized access detection device according to claim 1, wherein
the operation target system is a system in a cloud environment, and is a system including one or a plurality of cloud computing services.

9. An unauthorized access detection method comprising:
by a computer, storing, in a storage device, elevated access management data that is data related to an elevated access operation performed on an operation target system by a user,
the elevated access operation being an operation within a range of temporarily elevated access authority,
an operation log source that is a source of an operation log for an operation performed by the user on the operation target system being configured to accumulate operation logs of operations as the elevated access operation on the operation target system, as well as operation logs of operations other than the elevated access operation;
by a computer, acquiring an operation history that is one or more operation logs from the operation log source, and storing the operation history in the storage device;
by a computer, acquiring the elevated access management data from the storage device;
by a computer, performing determination on whether a response is required that is a determination on whether an operation identified from the operation history is an operation as an unauthorized access not matching an operation identified from the elevated access management data; and
by a computer, providing a result of the determination on whether a response is required.
